(19) United States
(12) Patent Application Publication
(10) Pub. No.: US 2023/0117987 A1
(43) Pub. Date: Apr. 20, 2023

(54) TOFU CONVEYING MACHINE

(71) Applicant: TAKAI TOFU & SOYMILK EQUIPMENT CO., Ishikawa (JP)

(72) Inventors: Toichiro TAKAI, Ishikawa (JP); Taku KITAURA, Ishikawa (JP); Shigeto TAKENAKA, Ishikawa (JP)

(73) Assignee: TAKAI TOFU & SOYMILK EQUIPMENT CO., Ishikawa (JP)

(21) Appl. No.: 17/506,078

(22) Filed: Oct. 20, 2021

(51) Int. Cl. B65B 25/06; A23L 11/45

(52) U.S. Cl. CPC B65B 25/06; A23L 11/45

(57) ABSTRACT

A tofu conveying machine includes a conveyor, a support member, and an elevation device. The conveyor is configured to convey tofu placed thereon. The support member is configured to support at least a portion of the conveyor from below, and the portion allows the tofu to be placed thereon. The elevation device is configured to elevate and lower the support member.

### FIELD

The present disclosure relates to a tofu conveying machine.

### BACKGROUND

For a conveyor, in particular a continuous shaping machine, for conveying coagulated matter that is used in a shaping process of tofu (also known as bean curd), how to deal with squeezed liquid produced at the time of squeezing coagulated matter is an important issue. Such liquid flows to under a conveying member, such as a cloth belt or a conveyor, that is driven so as to circulate and seeps into, for example, the gap between the conveying member and a slide member on which the conveying member slides, causing production of dirt and bacteria.

Furthermore, keeping a conveyor for conveying coagulated matter in a prescribed shape (i.e., keeping it straight or horizontal) is an important factor in manufacturing high-quality tofu products.

Patent Literature 1 discloses a continuous shaping machine for manufacturing tofu products. This machine is equipped with two (upper and lower) sets of an endless filter cloth belt that circulates outside and an endless conveyor that circulates inside and squeeze-shapes soymilk coagulated matter while sandwiching it between the upper filter cloth belt and conveyor and the lower filter cloth belt and conveyor. A heating unit is provided that sterilizes, by heating, a prescribed range of a return route (from an end portion to a start portion of a conveyance path where soymilk coagulated matter is sandwiched) of each of the circulation routes of the filter cloth belts.

Patent Literature 2 discloses an automatic tofu shaping machine using endless conveyors. This machine is equipped with a lower endless conveyor that is driven so as to move along a base stage, an upper endless conveyor that is driven so as to move along the base stage, an upper endless filter cloth that is driven so as to move along the lower endless conveyor, and a lower endless filter cloth that is driven so as to move along the upper endless conveyor. Load support members are disposed at lower positions (in a region where the conveyor becomes loose) inside the upper endless conveyor. Hook portions that slide being hooked on the load support members are attached to the upper endless conveyor.
Patent Literature 1: WO-A1-2017/056280
Patent Literature 2: JP-A-2010-273653

### SUMMARY

The machine of Patent Literature 1 can sterilize the prescribed region of the return route by heating. In the machine of Patent Literature 2, the endless conveyor is supported by the load support members and hook members that are disposed inside the conveyor. In either machine, particularly in rails for supporting the lower conveyor or the lower endless conveyor, a slide member is fixed to a rigid rail member by screwing.

With recent trends of elongation of best-before dates of foods and more severe requirements for sanitation, not only are viable bacteria counts in final products need to be checked but also secondary pollution in intermediate processes is considered an important issue in a situation that hygiene control such as Hazard Analysis and Critical Control Points (HACCP) comes to be employed more broadly. However, related-art machines do not satisfy these requirements sufficiently.

The present disclosure has been made in view of the above circumstances, and an object thereof is to provide a tofu conveying machine in which further consideration is given to sanitation.

A tofu conveying machine according to the disclosure includes: a conveyor configured to convey tofu placed thereon; a support member configured to support at least a portion of the conveyor from below, the portion allowing the tofu to be placed thereon; and an elevation device configured to elevate and lower the support member.

In the tofu conveying machine according to the disclosure, for example, the conveyor includes an endless conveyor configured to circulate, and the support member is disposed at a feed portion in the endless conveyor, the tofu placed on the feed portion being fed to a next process. In the case of the tofu conveying machine including a pair of (upper and lower) endless conveyors, the support member is disposed mainly at the feed portion of the lower endless conveyor.

In the tofu conveying machine according to the disclosure, for example, the elevation device includes a position fixing device configured to fix a position of the support member at a prescribed position.

In the tofu conveying machine according to the disclosure, for example, the support member includes: a base member; and a slide member detachably attached to the base member, the slide member including a slide layer configured to contact the conveyor.

In the tofu conveying machine according to the disclosure, for example, the slide member is detachable from the base member in a state in which the support member is stopped at a prescribed position by the elevation device.

In the tofu conveying machine according to the disclosure, for example, the slide layer is made of a resin and has a smooth surface or a layer having many rollers.

In the tofu conveying machine according to the disclosure, for example, the base member and the slide member have a structure that allows the base member and the slide member to be positioned with respect to each other at prescribed relative positions.

In the tofu conveying machine according to the disclosure, for example, the support member has a draining structure.

In the tofu conveying machine according to the disclosure, for example, the support member has a draining structure, and the draining structure also serves as a positioning structure that allows the base member and the slide member to be positioned with respect to each other at prescribed relative positions.

In the tofu conveying machine according to the disclosure, for example, the tofu conveying machine further includes: a cleaning tank which stores cleaning liquid for cleaning the slide member, and at least the slide member is allowed to be immersed in the cleaning liquid in a state in which the support member is lowered by the elevation device.

In the tofu conveying machine according to the disclosure, for example, the conveyor and the slide member are allowed to be immersed in the cleaning liquid in a state in which the support member is lowered by the elevation device, and the conveyor is allowed to run in a state in which the conveyor is immersed in the cleaning liquid.

In the tofu conveying machine according to the disclosure, for example, the endless conveyor includes: a first endless conveyor allowed to be supported by the support member from below; and a second endless conveyor located over the first endless conveyor, the second endless conveyor being configured to circulate in synchronism with the first endless conveyor, and the tofu is placed between the first endless conveyor and the second endless conveyor.

In the tofu conveying machine according to the disclosure, for example, the first endless conveyor and the second endless conveyor are arranged such that an interval between the first endless conveyor and the second endless conveyor decreases in a circulation direction.

In the tofu conveying machine according to the disclosure, for example, the first endless conveyor and the second endless conveyor are arranged such that a pressure for sandwiching the tofu increases in a circulation direction.

In the tofu conveying machine according to the disclosure, for example, the tofu conveying machine further includes a cleaning tank in which cleaning liquid for cleaning the first endless conveyor, the second endless conveyor, and the support member is stored, the first endless conveyor, the second endless conveyor, and the support member are allowed to be immersed in the cleaning tank in a state in which the support member is lowered by the elevation device, and the first endless conveyor and the second endless conveyor are allowed to circulate in a state in which the first endless conveyor and the second endless conveyor are immersed in the cleaning liquid.

In the tofu conveying machine according to the disclosure, the maintenance of the conveying machine is facilitated as a whole, whereby the risk of secondary contamination is lowered and improvements are made in sanitation. Furthermore, it becomes possible to increase the safety and reliability that are indispensable for foods.

### BRIEF DESCRIPTION OF DRAWINGS

FIGS. 1A-1D show a tofu conveying machine according to a first embodiment; FIG. 1A is a front view at the time of tofu conveyance, FIG. 1B is a sectional view taken along a broken line in FIG. 1A, FIG. 1C is a front view of the tofu conveying machine at the time of maintenance, and FIG. 1D is a sectional view taken along a broken line in FIG. 1C;

FIGS. 2A-2D show a tofu conveying machine according to a second embodiment; FIG. 2A is a front view at the time of tofu conveyance, FIG. 2B is a sectional view taken along a broken line in FIG. 2A, FIG. 2C is a front view of the tofu conveying machine at the time of maintenance, and FIG. 2D is a sectional view taken along a broken line in FIG. 2C;

FIGS. 3A-3D show a tofu conveying machine according to a third embodiment; FIG. 3A is a front view at the time of tofu conveyance, FIG. 3B is a sectional view taken along a broken line in FIG. 3A, FIG. 3C is a front view of the tofu conveying machine at the time of maintenance, and FIG. 3D is a sectional view taken along a broken line in FIG. 3C;

FIGS. 4A-4D show a tofu conveying machine according to a fourth embodiment; FIG. 4A is a front view at the time of tofu conveyance, FIG. 4B is a sectional view taken along a broken line in FIG. 4A, FIG. 4C is a front view of the tofu conveying machine at the time of maintenance, and FIG. 4D is a sectional view taken along a broken line in FIG. 4C;

FIGS. 5A-5D show a support member according to Example 1; FIG. 5A is a front view when it is in use, FIG. 5B is a side view corresponding to FIG. 5A, FIG. 5C is an exploded front view, and FIG. 5D is a side view corresponding to FIG. 5C;

FIGS. 6A-6D show a support member according to Example 2; FIG. 6A is a front view when it is in use, FIG. 6B is a side view corresponding to FIG. 6A, FIG. 6C is an exploded front view, and FIG. 6D is a side view corresponding to FIG. 6C;

FIGS. 7A-7D show a support member according to Example 3; FIG. 7A is a front view when it is in use, FIG. 7B is a side view corresponding to FIG. 7A, FIG. 7C is an exploded front view, and FIG. 7D is a side view corresponding to FIG. 7C;

FIGS. 8A-8D show a support member according to Example 4; FIG. 8A is a front view when it is in use, FIG. 8B is a side view corresponding to FIG. 8A, FIG. 8C is an exploded front view, and FIG. 8D is a side view corresponding to FIG. 8C;

FIGS. 9A-9D show a support member according to Example 5; FIG. 9A is a front view when it is in use, FIG. 9B is a side view corresponding to FIG. 9A, FIG. 9C is an exploded front view, and FIG. 9D is a side view corresponding to FIG. 9C;

FIGS. 10A-10D show a support member according to Example 6; FIG. 10A is a front view when it is in use, FIG. 10B is a side view corresponding to FIG. 10A, FIG. 10C is an exploded front view, and FIG. 10D is a side view corresponding to FIG. 10C;

FIGS. 11A and 11B a front view and a side view, respectively, showing a support member in a related-art;

FIGS. 12A-12D show a tofu conveying machine according to a fifth embodiment; FIG. 12A is a front view at the time of tofu conveyance, FIG. 12B is a sectional view taken along a broken line in FIG. 12A, FIG. 12C is a front view of the tofu conveying machine at the time of maintenance, and FIG. 12D is a sectional view taken along a broken line in FIG. 12C; and

FIGS. 13A-13D show a tofu conveying machine according to a sixth embodiment; FIG. 13A is a front view at the time of tofu conveyance, FIG. 13B is a sectional view taken along a broken line in FIG. 13A, FIG. 13C is a front view of the tofu conveying machine at the time of maintenance, and FIG. 13D is a sectional view taken along a broken line in FIG. 13C.

### DETAILED DESCRIPTION

Embodiments of the present disclosure will be hereinafter described in detail with reference to the drawings.

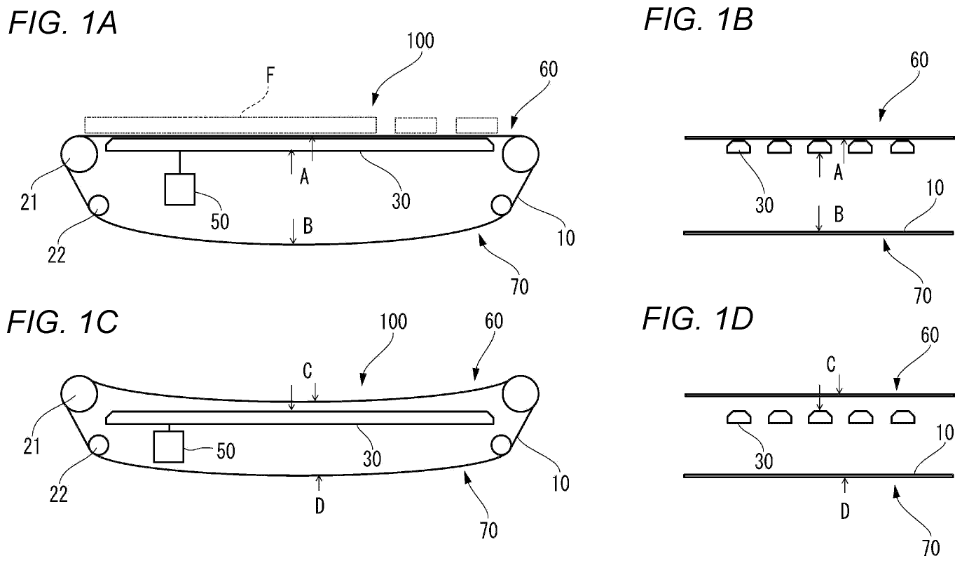

FIGS. 1A-1D show a tofu conveying machine 100 according to a first embodiment of the disclosure. The tofu conveying machine 100 is a machine that is used for conveying tofu placed on a conveyor in a process of shaping tofu products from dough of silken tofu, firm tofu, deep-fried tofu, or the like. This machine is applied to tofu having various shapes such as a sheet, a belt, a narrow band, a block, and a cake shape; there are no particular limitations on the tofu shape. There are no particular limitations on the material, type, etc. of tofu, either.

The tofu conveying machine 100 is equipped with a conveyor 10 for conveying tofu F placed thereon, support members 30 for supporting at least a portion, on which the tofu F is placed, of the conveyor 10 from below, and an elevation device 50 for elevating and lowering the support members 30.

In this embodiment, the conveyor 10 is an endless conveyor that has no particular ends and circulates in such a state as to be wound on rotary rollers 21, 22, etc. However, the conveyor 10 need not always be an endless one. The conveyor 10 conveys the tofu that is placed directly or indirectly on a resin belt, a cloth belt, a Caterpillar (registered trademark; i.e., a flat-bar conveyor having chains on the two respective sides), a steel belt, or the like.

The portion (in this example, top portion) of the endless conveyor 10, on which the tofu F is placed, is a feed portion 60 for feeding the tofu F to the next process, and the support members 30 are provided in the endless conveyor 10 so as to support the feed portion 60. The tofu F can be conveyed stably with such support by the support members 30. The portion (in this example, bottom portion), other than the feed portion 60, of the endless conveyor 10 is a return portion 70 that returns to a place to put the tofu F again after conveying the previous tofu F. In this embodiment, no support member is provided for the return portion 70. Each support member 30 includes a base member and a slide member that is attached to the base member in a detachable manner and is to come into contact with the conveyor 10 (they will be described later in detail). All or part of the slide members may be replaced by rotary members, such as rollers, that rotate smoothly.

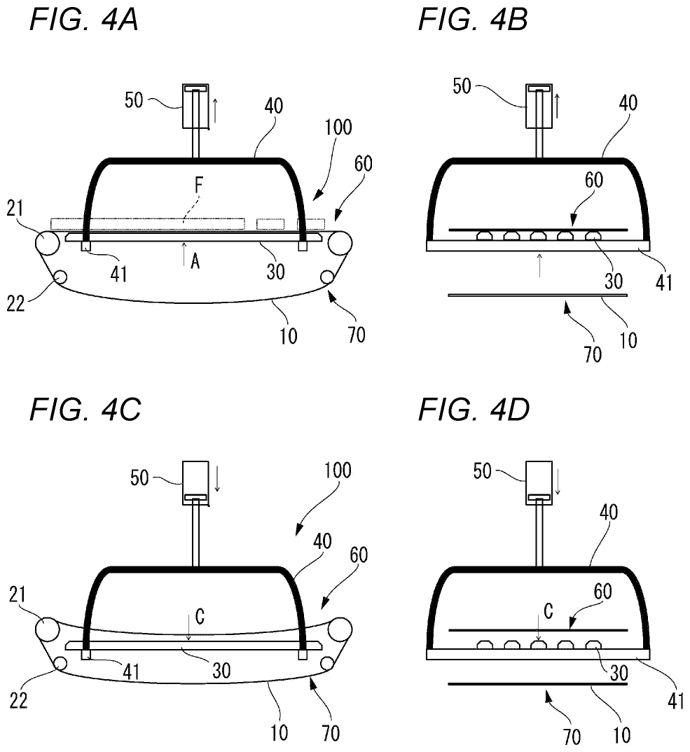

The elevation device 50 is equipped with a position fixing device for fixing the position of the support members 30 at a prescribed position as shown in FIG. 1A. The support members 30 is moved upward or downward through action of the elevation device 50 and the conveyor 10 is deformed accordingly. The elevation device 50 is omitted in the figures showing the other embodiments except for FIGS. 4A-4D.

More specifically, as shown in FIGS. 1A and 1B, as the support members 30 are elevated, the feed portion 60 of the conveyor 10 is also elevated being pushed up by the support members 30 as indicated by arrow A and the tofu F is thereby conveyed smoothly. The return portion 70 hangs down as indicated by arrow B.

On the other hand, as shown in FIGS. 1C and 1D, as the support members 30 is lowered, the feed portion 60 of the conveyor 10 comes to lose support by the support members 30 (or the support is weakened) and comes to hang down due to its own weight as indicated by arrow C. When the feed portion 60 hangs down, the return portion 70 goes up a little as indicated by arrow D. In the state shown in FIGS. 1C and 1D, a gap is formed at least between the conveyor 10 and the support members 30, whereby various kinds of maintenance work, in particular, manual cleaning, automatic cleaning using cleaning nozzles, etc., are facilitated and hence the performance of the cleaning is enhanced.

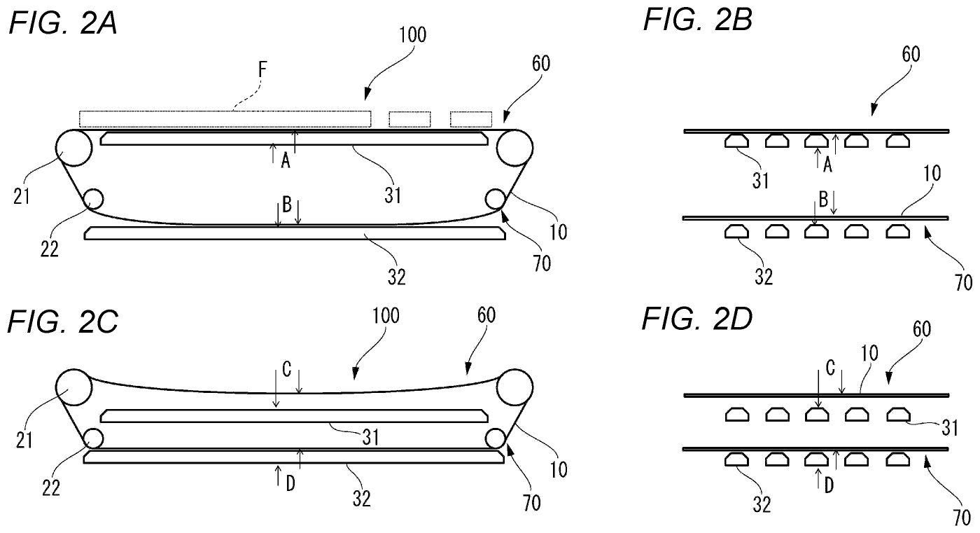

FIGS. 2A-2D show a tofu conveying machine 100 according to a second embodiment of the disclosure. This embodiment is different from the first embodiment in that not only support members 31 for supporting the feed portion 60 but also another support members 32 for supporting the return portion 70 from below are provided. The support members 31 and the support members 32 are moved in opposite directions in the top-bottom direction. More specifically, as shown in FIGS. 2A and 2B, as the support members 31 are elevated, the feed portion 60 of the conveyor 10 is also elevated being pushed up by the support members 31 as indicated by arrow A and the tofu F is thereby conveyed smoothly. On the other hand, since the support members 32 are lowered as indicated by arrow B, the return portion 70 of the conveyor 10 loses support by the support members 32 (or the support is weakened) and hangs down and becomes loose due to its own weight as indicated by arrow B.

On the other hand, as shown in FIGS. 2C and 2D, as the support members 31 are lowered, the feed portion 60 of the conveyor 10 comes to lose support by the support members 31 (or the support is weakened) and comes to hang down due to its own weight as indicated by arrow C. Since the support members 32 are elevated contrary to the lowering of the support members 31, the return portion 70 of the conveyor 10 goes up as indicated by arrow D. As a result, the degree of loosening of the feed portion 60 is increased, whereby various kinds of maintenance work, in particular, cleaning, are facilitated.

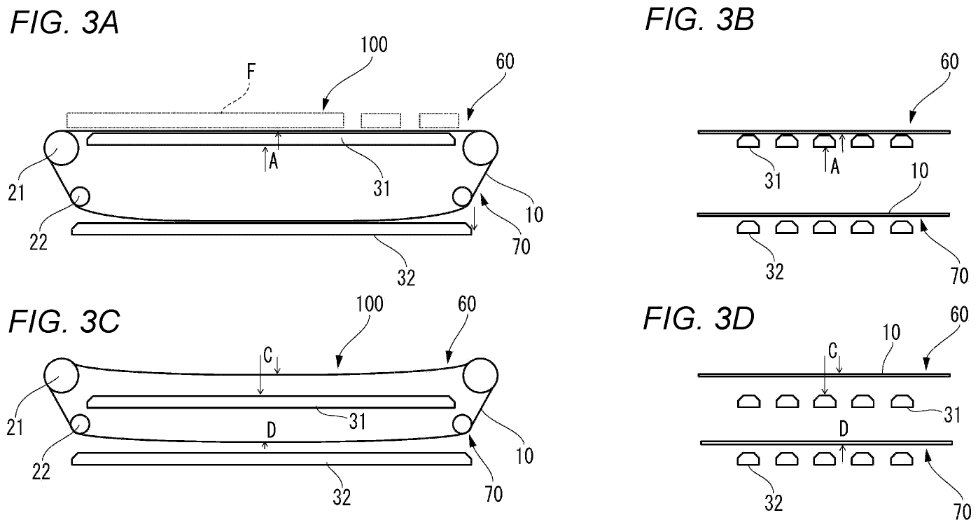

FIGS. 3A-3D show a tofu conveying machine 100 according to a third embodiment of the disclosure. This embodiment is similar to the second embodiment and is different from it in that only the support members 31 for supporting the feed portion 60 are elevated and lowered and the support members 32 for supporting the return portion 70 are fixed at a prescribed position. More specifically, as shown in FIGS. 3A and 3B, as the support members 31 are elevated, the feed portion 60 of the conveyor 10 is also elevated being pushed up by the support members 31 as indicated by arrow A and the tofu F is thereby conveyed smoothly. On the other hand, since the support members 32 are fixed at the prescribed position and the return portion 70 of the conveyor 10 is in contact with the top surface of the support members 32.

On the other hand, as shown in FIGS. 3C and 3D, as the support members 31 are lowered, the feed portion 60 of the conveyor 10 comes to lose support by the support members 31 (or the support is weakened) and comes to hang down due to its own weight as indicated by arrow C. Although the support members 32 are fixed at the prescribed position, the degree of loosening of the return portion 70 is low and hence goes up because of the loosening of the feed portion 60. As a result, a large gap is formed both between the feed portion 60 and the support members 31 and between the return portion 70 and the support members 32, whereby various kinds of maintenance work, including cleaning, are facilitated.

FIGS. 4A-4D show a tofu conveying machine 100 according to a fourth embodiment of the disclosure. This embodiment is similar to the first embodiment and is different from it in that the elevation device 50 is of such a type as to elevate or lower the support members 30 for the feed portion 60 in a state that they hang down from above. Such a mechanism as an air cylinder is employed in the elevation device 50.

As shown in FIGS. 4A and 4B, as the support members 30 are elevated, the feed portion 60 of the conveyor 10 is also elevated being pushed up by the support members 30 as indicated by arrow A and the tofu curd F is thereby conveyed smoothly. The return portion 70 hangs down and is loosened.

On the other hand, as shown in FIGS. 4C and 4D, as the support members 30 is lowered, the feed portion 60 of the conveyor 10 comes to lose support by the support members 30 (or the support is weakened) and comes to hang down due to its own weight as indicated by arrow C. In the state shown in FIGS. 4C and 4D, a gap is formed at least between the conveyor 10 and the support members 30, whereby various kinds of maintenance work, in particular, manual cleaning, automatic cleaning using cleaning nozzles, etc., are facilitated and hence the performance of the cleaning is enhanced.

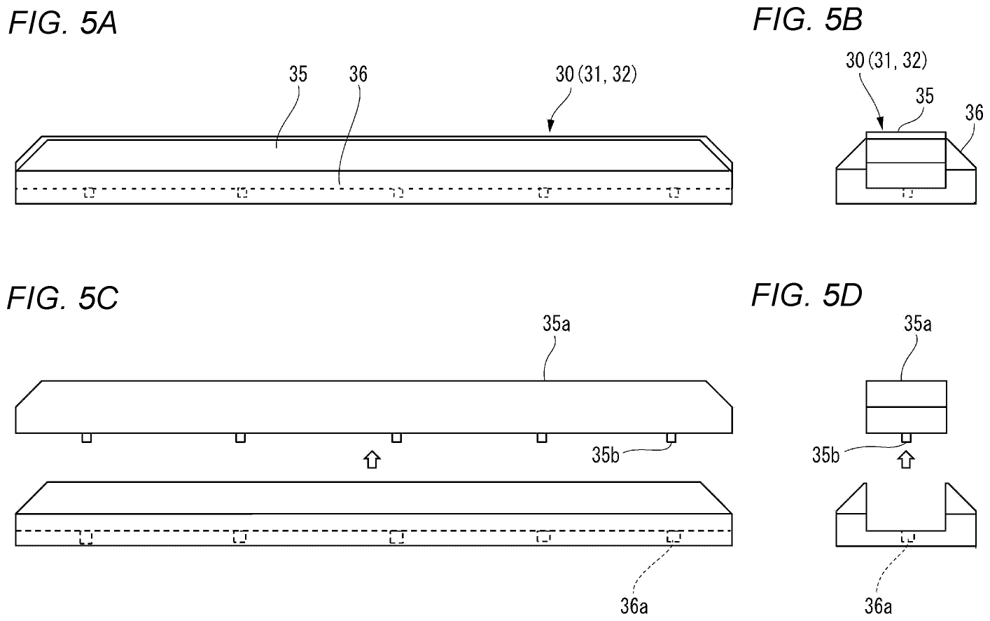

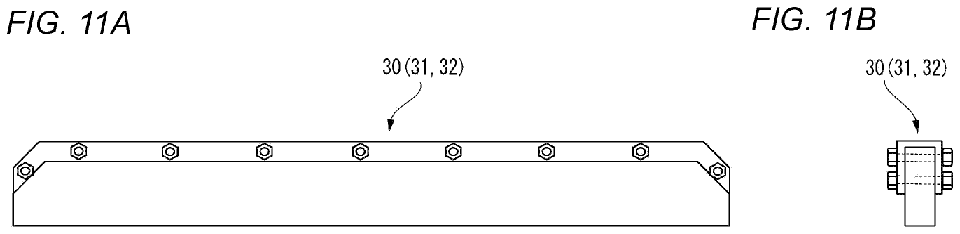

FIGS. 5A-5D to FIGS. 10A-10D show various Examples of each support member 30 (31 or 32) and FIGS. 11A and 11B show a support member in a related-art.

FIGS. 5A-5D show a support member 30 (31 or 32) according to Example 1 which includes a base member 36 and a slide member 35 which is attached to the base member 36 and is to come into contact with the conveyor 10. The base member 36 is a base portion of the support member 30 (31 or 32) and the slide member 35 is attached to its recess portion in a detachable manner as shown in FIG. 5B. The slide member 35 has a slide layer 35a to come into contact with the conveyor 10. Although there are no particular limitations on the materials of the base member 36 and the slide member 35, it is preferable that at least the slide layer 35a of the slide member 35 be made of a material capable of lowering the frictional resistance with respect to the conveyor 10. For example, it is preferable that the slide layer 35a be made of a low frictional resistance material such as a resin and have a smooth surface. Alternatively, the slide member 35 may be a roller-type slide member having many rotary members, such as rollers, that rotate smoothly. A worker can detach the slide member 35 from the base member 36 in a state that the support member 30 (31 or 32) is stopped at a prescribed position by the elevation device 50.

As shown in FIGS. 5A and 5B, the slide member 35 is fitted in the recess portion of the base member 36 when the tofu conveying machine 100 is in use. As shown in FIGS. 5C and 5D, the slide member 35 is detached from the base member 36 at the time of maintenance including cleaning. This structure facilitates maintenance work.

On the other hand, in the support member in a related-art shown in FIGS. 11A and 11B, a base member 36 and a slide member 35 are fixed to each other by means of bolts, screws, or the like and hence cannot be detached from the slide member 35 easily. Thus, squeezed liquid, dirt, cleaning liquid, etc. that have entered the gap between the base member 36 and the slide member 35 are likely overlooked and hence possibly become a source of secondary pollution by bacteria, which is a sanitary problem.

Water (including squeezed liquid) that is produced during use of the tofu conveying machine 100 enters the slide member 35 through openings (cuts; not shown) formed therein, passes projected passages 35b provided on the bottom surface of the slide member 35, passes recessed passages 36a provided in the base member 36, and is drained from the support member 30 (31 or 32). The projected passages 35b and the recessed passages 36a serve as such draining structures. Furthermore, since the passages 35b are fitted in the respective passages 36a, positional deviation between the slide member 35 and the base member 36 can be prevented when the conveyor 10 slides on the slide member 35. That is, the draining structures formed by the projected passages 35b and the recessed passages 36a also serve as positioning structures for positioning the base member 36 and the slide member 35 with respect to each other. Alternative structures are possible in which the slide member 35 are formed with recessed passages and the base member 36 is formed with projected passages.

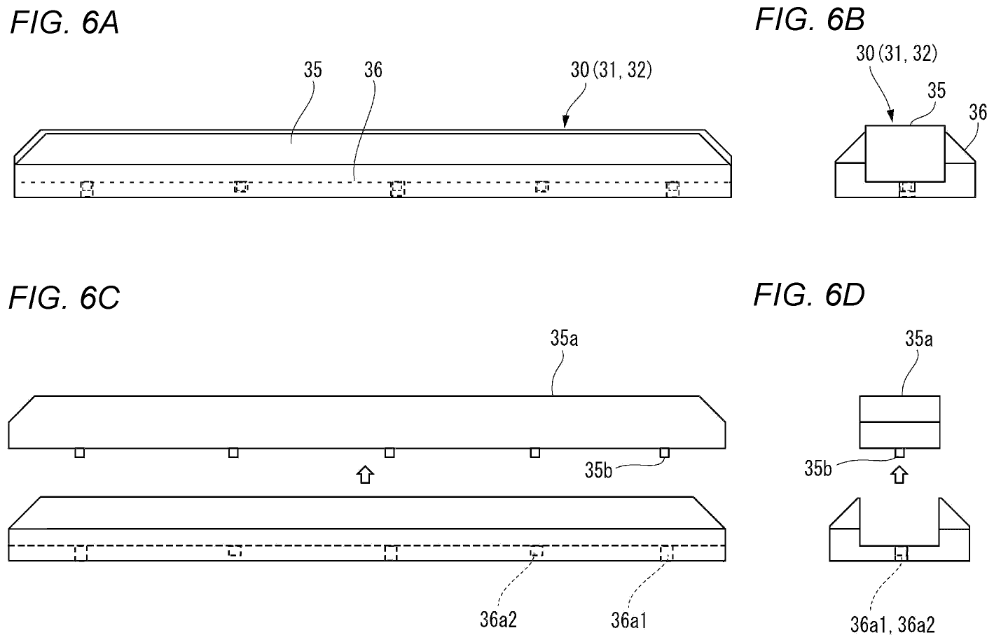

FIGS. 6A-6D show a support member 30 (31 or 32) according to Example 2. The base member 36 is formed with passages 36a1 which penetrate to its bottom surface and passages 36a2 which do not reach its bottom surface. With these structures, during cleaning, stagnant liquids are not prone to be formed and hence liquid can be drained smoothly. It is even better to form all of passages as passages 36a1 which penetrate to the bottom surface of the base member 36. Recessed passages formed in the base member 36 may be inclined so as to accelerate drainage.

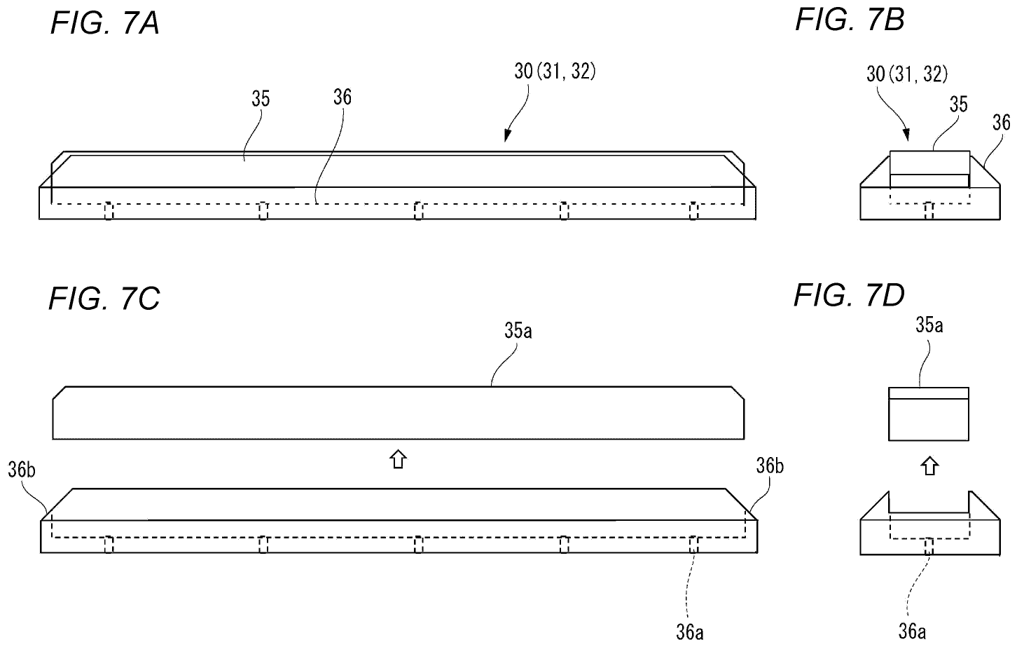

FIGS. 7A-7D show a support member 30 (31 or 32) according to Example 3. The base member 36 is formed with, at its two respective ends, walls 36b which can prevent positional deviation of the base member 36 to the slide member 35 more reliably.

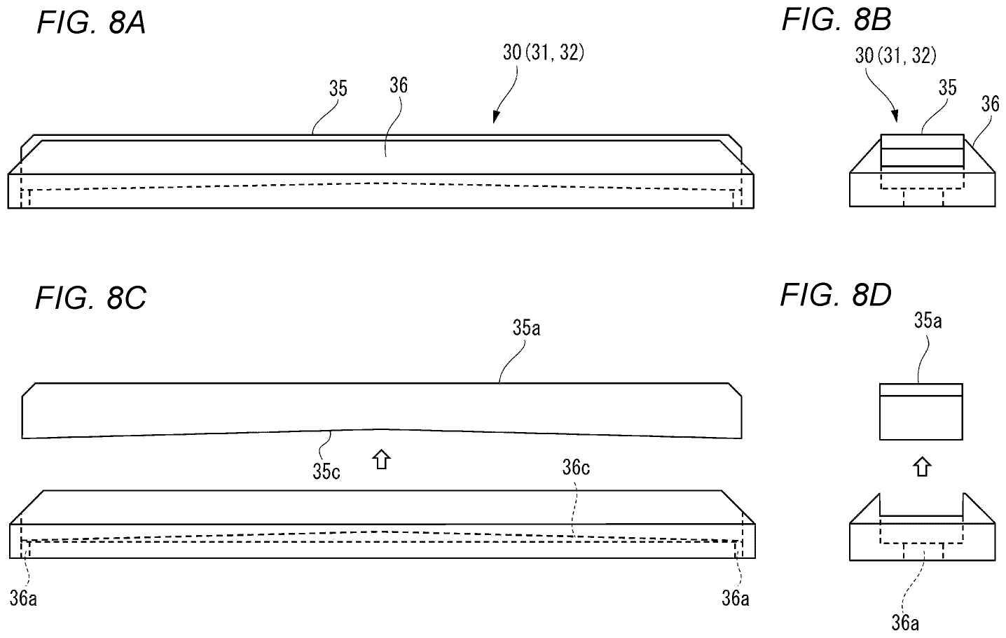

FIGS. 8A-8D show a support member 30 (31 or 32) according to Example 4. The bottom surface of the slide member 35 includes slant surfaces 35c and the base member 36 has slant surfaces 36c which conform to the respective slant surfaces 35c of the slide member 35. With this structure, produced water flows across the slant surfaces 35c and 36c which go down toward the two respective ends of the support member 30 (31 or 32) and is drained smoothly past passages 36a which are formed in the base member 36 at its two respective ends.

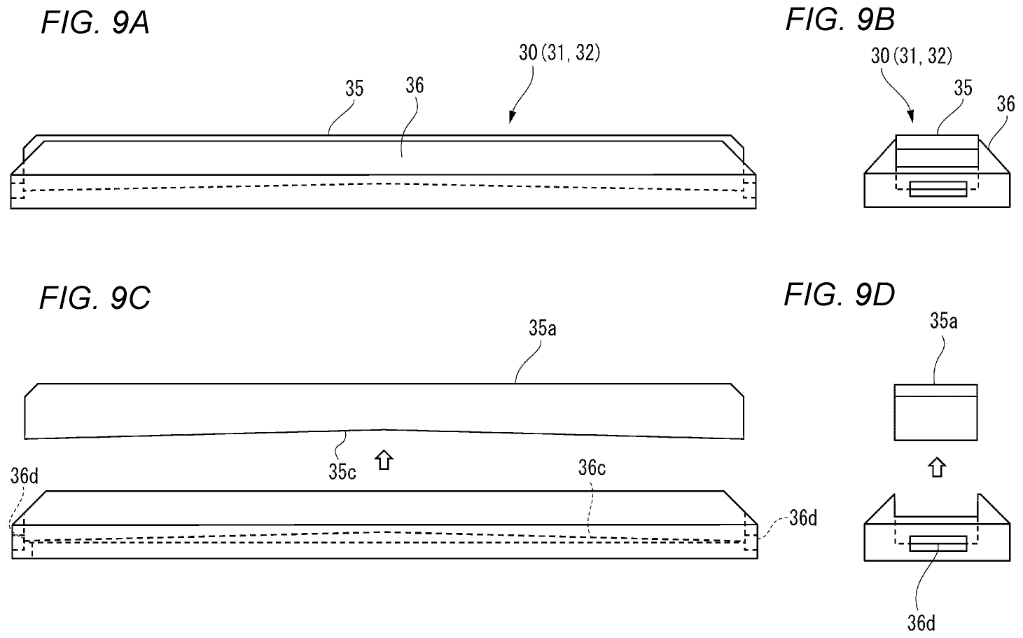

FIGS. 9A-9D show a support member 30 (31 or 32) according to Example 5. Example 5 is similar to Example 4 and horizontal passages 36d which extend in the horizontal direction and are exposed in the two respective side surfaces of the base member 36. Also with this structure, produced water flows across the slant surfaces 35c and 36c which go down toward the two respective ends of the support member 30 (31 or 32) and is drained smoothly past the horizontal passages 36d.

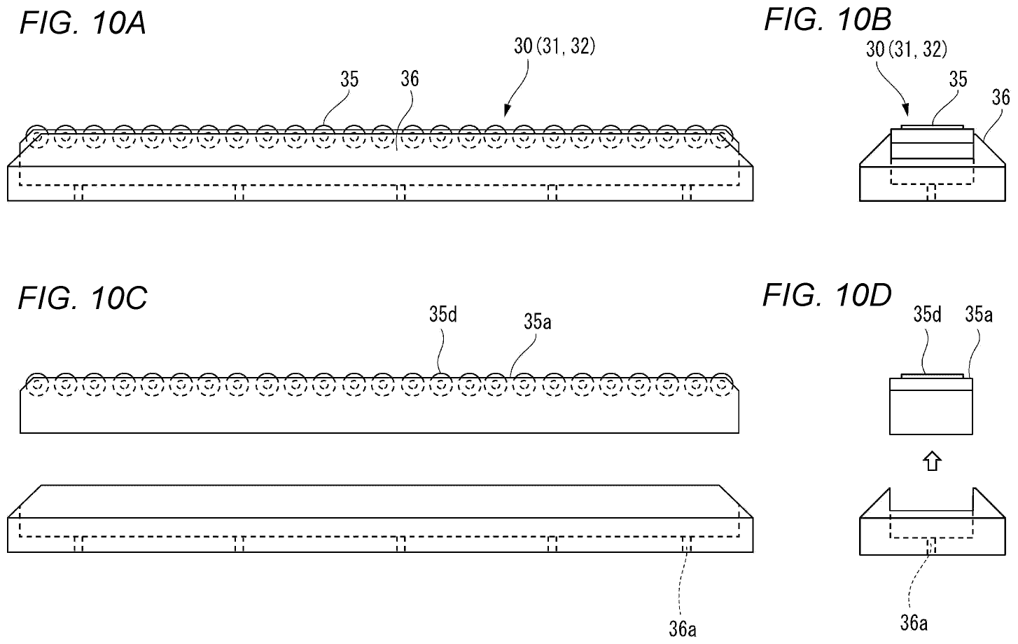

FIGS. 10A-10D show a support member 30 (31 or 32) according to Example 6. The slide layer 35a of the slide member 35 is provided with plural rotatable slide rollers 35d. Since the slide rollers 35d are rotated when being in contact with the conveyor 10 that is running, the friction between the slide member 35 and the conveyor 10 can be lowered. In particular, where the conveyor 10 is a belt made of a hard material such as steel, the support member 30 (31 or 32) according to this Example is useful. For example, the slide rollers 35d may be cylindrical rollers (not shown) that are attached to rotary shafts via bearings, respectively, and rotate smoothly around the shafts or they may be spherical ball rollers (not shown).

Although the support members 30 (31 or 32) according to the various Examples have been described above, there are no particular limitations on the configuration of each support member 30 (31 or 32). For example, water draining passages may be formed by forming recesses in each of the slide member 35 and the base member 36 and fitting hollow-cylinder-shaped pins into the recesses of the slide member 35 and the base member 36.

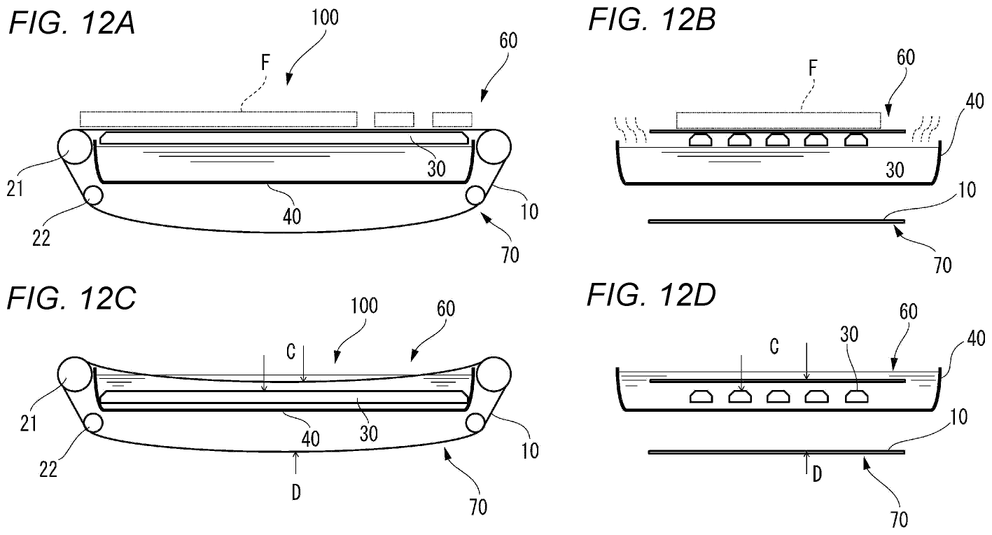

FIGS. 12A-12D show a tofu conveying machine 100 according to a fifth embodiment of the disclosure. This embodiment is different from the first embodiment in that the former is further equipped with a cleaning tank 40 in which cleaning liquid for cleaning the slide members 35 of the support members 30 is stored. When the elevation device 50 has lowered the support members 30, at least the slide members 35 can be immersed in the cleaning liquid. More specifically, as shown in FIGS. 12A and 12B, when the tofu conveying machine 100 is in use, the support members 30 are located not in the cleaning tank 40 but over it. On the other hand, as shown in FIGS. 12C and 12D, when the elevation device 50 has lowered the support members 30, the feed portion 60 of the conveyor 10 and the entire support member 30 (or at least the slide members 35) can be immersed in the cleaning liquid. The conveyor 10 can run even in a state that it is immersed in the cleaning liquid stored in the cleaning tank 40. This structure facilitates cleaning of the conveyor 10 and the support members 30.

Related-art machines employ a configuration that plural rollers are provided separately and a conveyor is bent using the rollers so as to move to another position where it is immersed in a cleaning tank; however, this configuration is complex. In this embodiment, the cleaning tank 40 is disposed at the destination of the movement of the support members 30 by the elevation device 50 (in this embodiment, under the support members 30) and hence the support members 30 can be cleaned by a simple configuration. Automatic circulatory cleaning can be performed by immersing a hung portion, hung because of its own weight, of the conveyor 10 in the cleaning tank 40 while the conveyor 10 is circulating even if it is a hard one such as a steel belt conveyor.

There are no particular limitations on the form of the cleaning tank 40. The cleaning liquid provided in the cleaning tank 40 may be any of various kinds of liquid such as hot water (e.g., 60-100° C.) or cleanser (e.g., alkaline cleanser, acidic cleanser, or antibacterial agent). If necessary, the cleaning tank 40 may be equipped with a heating means, a temperature control means, or the like.

An elevation device for elevating and lowering the cleaning tank 40 may be provided. Although in this embodiment the cleaning tank 40 is disposed at such a position that the feed portion 60 can be immersed in it, another cleaning tank may be provided at such a position that the return portion 70 can be immersed in it. As another alternative, a device for blowing heated water vapor over the cleaning tank 40 where boiling water is stored, whereby the temperature of the tofu F being conveyed by the conveyor 10 is increased or maintained while the tofu conveying machine 100 is in operation, to increase its elasticity and binding property and to maintain a good sanitary environment by suppressing increase of microbes.

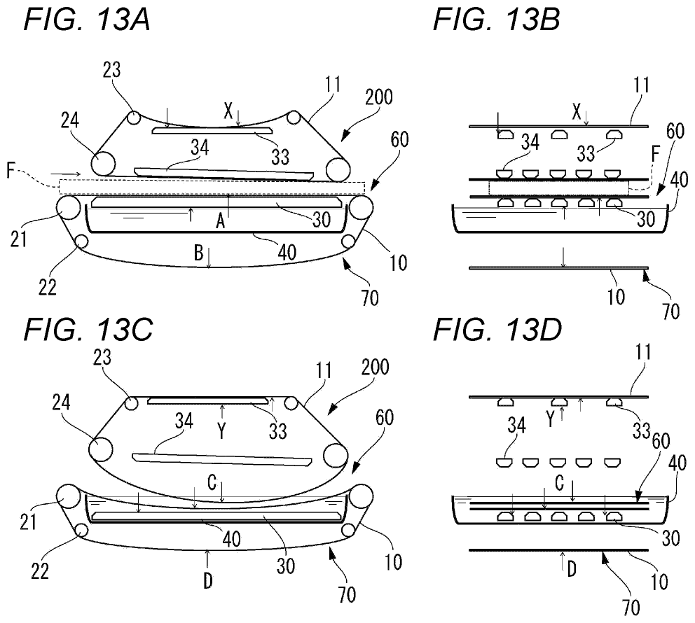

FIGS. 13A-13D show a tofu conveying machine 200 according to a sixth embodiment of the disclosure. This embodiment is different from the fifth embodiment in that another endless conveyor 11 is provided over the conveyor 10 to press the tofu F continuously; the tofu conveying machine 200 also serves as a continuous shaping machine. More specifically, in this embodiment, the two endless conveyors are provided, that is, the first endless conveyor 10 which is supported from below by the support members 30 and the second endless conveyor 11 which is located over the first endless conveyor 10, is wound on rollers 23 and 24, and circulates in synchronism with it. The tofu F is disposed between the first endless conveyor 10 and the second endless conveyor 11.

The tofu conveying machine 200 is further equipped with another set of support members 34 for pushing a feed portion, to come into contact with the tofu F, of the upper, second endless conveyor 11 downward to accelerate the squeezing of the tofu F. Support members 33 for supporting a return portion of the second endless conveyor 11 from below are also provided. Whereas the support members 34 are fixed at a prescribed position, the support members 33 can be elevated and lowered in the top-bottom direction.

As shown in FIGS. 13A and 13B, while the tofu conveying machine 200 is in use, the support members 33 are lowered and hence the return portion of the second endless conveyor 11 hangs down and is loose. On the other hand, as shown in FIGS. 13C and 13D, at the time of maintenance work including cleaning, the support members 33 are elevated to suppress loosening of the return portion of the second endless conveyor 11. As a result, the feed portion of the second endless conveyor 11 becomes loose and hangs down to be immersed in the cleaning tank 40 together with the feed portion of the first endless conveyor 10. Thus, the two conveyors 10 and 11 can be cleaned at the same time. That is, when the support members 30 have been lowered by the elevation device 50, the feed portion of the first endless conveyor 10, the feed portion of the second endless conveyor 11, and the slide member 35 of the support members 30 can be immersed in the cleaning liquid and the first endless conveyor 10 and the second endless conveyor 11 can circulate with their fed portions immersed in the cleaning liquid.

The first endless conveyor 10 and the second endless conveyor 11 are arranged so that the interval between their feed portions decreases in their movement direction and the pressure for sandwiching the tofu F between them increases in their movement direction. This strengthens the tofu F squeezing action.

In conveyors for conveying raw tofu, how to deal with squeezed liquid produced at the time of squeezing the tofu is an important issue from the sanitary point of view. In the conveying machine according to the disclosure, when it is not in use, the support members for supporting the conveyor are separated from the conveyor, whereby a gap can be formed between the support members and the conveyor. As a result, various kinds of maintenance work including cleaning is facilitated and hence improvements in sanitation are expected.

Each of the support members used in the conveying machine according to the disclosure is configured so that the slide member to come into contact with the conveyor and the base member for supporting the slide member can be detached from each other easily. Thus, squeezed liquid, dirt, cleaning liquid, etc. that are prone to enter the gap between the slide member and the base member can be detached more easily and hence further improvements in sanitation are expected.

With the above-described contrivances, the maintenance of the conveying machine is facilitated as a whole, whereby improvements can be made in sanitation and, for example, propagation of various kinds of bacteria can be suppressed. It is expected to lower the risk that the tofu suffers secondary contamination, lower the risk of occurrence of residual chemicals, increase the safety and reliability that are indispensable for foods, and allow the tofu products to keep for a longer time (e.g., elongation of best-before dates or increase in the reliability of quality assurance). Furthermore, not only do curd products keep for a longer time but also the conditions of boiling water sterilization that is performed after packing of the tofu products can be relaxed (the heating temperature is lowered and the heating time is shortened). It is therefore expected that the degrees of taste degradation of the tofu products are lowered, leading to provision of delicious the tofu products.

The disclosure is not limited to the above embodiments and modifications, improvements, etc. can be made as appropriate. Furthermore, the material, shape, dimensions, related numerical values, form, number (where provided in plurality), location, etc. of each constituent element of each of the above-described embodiments are optional and are not limited in any manner as long as the disclosure can be realized.

1. A tofu conveying machine comprising:
a conveyor configured to convey tofu placed thereon;
a support member configured to support at least a portion of the conveyor from below, the portion allowing the tofu to be placed thereon; and
an elevation device configured to elevate and lower the support member.

2. The tofu conveying machine according to claim 1,
wherein the conveyor comprises an endless conveyor configured to circulate, and
wherein the support member is disposed at a feed portion in the endless conveyor, the tofu placed on the feed portion being fed to a next process.

3. The tofu conveying machine according to claim 1,
wherein the elevation device comprises a position fixing device configured to fix a position of the support member at a prescribed position.

4. The tofu conveying machine according to claim 1,
wherein the support member comprises:
a base member; and
a slide member detachably attached to the base member, the slide member comprising a slide layer configured to contact the conveyor.

5. The tofu conveying machine according to claim 4,
wherein the slide member is detachable from the base member in a state in which the support member is stopped at a prescribed position by the elevation device.

6. The tofu conveying machine according to claim 4,
wherein the slide layer is made of a resin and has a smooth surface.

7. The tofu conveying machine according to claim 4,
wherein the base member and the slide member have a structure that allows the base member and the slide member to be positioned with respect to each other at prescribed relative positions.

8. The tofu conveying machine according to claim 4,
wherein the support member has a draining structure.

9. The tofu conveying machine according to claim 4,
wherein the support member has a draining structure, and
wherein the draining structure also serves as a positioning structure that allows the base member and the slide member to be positioned with respect to each other at prescribed relative positions.

10. The tofu conveying machine according to claim 4, further comprising:
a cleaning tank which stores cleaning liquid for cleaning the slide member,
wherein at least the slide member is allowed to be immersed in the cleaning liquid in a state in which the support member is lowered by the elevation device.

11. The tofu conveying machine according to claim 10,
wherein the conveyor and the slide member are allowed to be immersed in the cleaning liquid in a state in which the support member is lowered by the elevation device, and
the conveyor is allowed to run in a state in which the conveyor is immersed in the cleaning liquid.

12. The tofu conveying machine according to claim 2,
wherein the endless conveyor comprises:
a first endless conveyor allowed to be supported by the support member from below; and
a second endless conveyor located over the first endless conveyor, the second endless conveyor being configured to circulate in synchronism with the first endless conveyor, and
wherein the tofu is placed between the first endless conveyor and the second endless conveyor.

13. The tofu conveying machine according to claim 12,
wherein the first endless conveyor and the second endless conveyor are arranged such that an interval between the first endless conveyor and the second endless conveyor decreases in a circulation direction.

14. The tofu conveying machine according to claim 12,
wherein the first endless conveyor and the second endless conveyor are arranged such that a pressure for sandwiching the tofu increases in a circulation direction.

15. The tofu conveying machine according to claim 12, further comprising:
a cleaning tank which stores cleaning liquid for cleaning the first endless conveyor, the second endless conveyor, and the support member,
wherein the first endless conveyor, the second endless conveyor, and the support member are allowed to be immersed in the cleaning tank in a state in which the support member is lowered by the elevation device, and
wherein the first endless conveyor and the second endless conveyor are allowed to circulate in a state in which the first endless conveyor and the second endless conveyor are immersed in the cleaning liquid.
